(19) United States
(12) Patent Application Publication
(10) Pub. No.: US 2012/0081259 A1
(43) Pub. Date: Apr. 5, 2012

(54) Inverted-U Crossed-Dipole Satcom Antenna

(76) Inventor: Florenio Pinili Regala, Costa Mesa, CA (US)

(21) Appl. No.: 12/897,885

(22) Filed: Oct. 5, 2010

(51) Int. Cl. H01Q 21/26

(52) U.S. Cl. 343/797

(57) ABSTRACT

An antenna assembly includes an antenna/radio interface, a body section connected to the antenna/radio interface, and a group of omnidirectional radiating elements, where each radiating element has a first portion with a first end and a second end, the first end being coupled to the body section and the second end being opposite the first end. Each radiating element also has a second portion with a first end, a second end, and a linear section between the first end and the second end, the first end of the second portion being coupled to the second end of the first portion. The second end of the second portion is opposite the first end of the second linear portion and spaced away from the body section by a distance, arranged so that the first portion of each element is substantially coaxial with the first portion of at least one other of the group of omnidirectional radiating elements, and arranged so that the first portion of each element is substantially orthogonal to the first portion of at least two other of the group of omnidirectional radiating elements, wherein the first portion and the second portion meet at a non-zero angle to each other.

### BACKGROUND OF THE INVENTION

1. Field of the Invention

This invention relates in general to satellite-communication (SATCOM) antennas and, more particularly, to a SATCOM antenna that that includes a crossed-dipole element with discrete portions in at least two planes, allowing it to radiate in a broad pattern spanning from high to low angles.

2. Description of the Related Art

Wireless communication is accomplished through use of a radio, which is well known by those having ordinary skill in the art, connected to a radiating element, or antenna, also well know by those having ordinary skill in the art. An antenna is an impedance-matching device used to absorb or radiate electromagnetic waves. The function of the antenna is to “match” the impedance of the propagating medium, which is usually air or free space, to the source.

Antennas are available in many different shapes and sizes. The particular shape and size of an antenna designed for a particular application depends on many factors, such as the operating frequency range, which direction(s) the radio waves are to be communicated, the expected environment the antenna will endure, size and/or shape restrictions, size and/or shape of the structure the antenna is to be installed upon, the presence of adjacent structures and materials, power efficiency, power limitations, impedance requirements, Voltage Standing Wave Ration (VSWR) requirements, application particulars, and many more.

One common use of antennas is on vehicles, either airborne or terrestrial. An antenna can be placed on various locations on the body of the vehicle, providing communication between the vehicle and other radio-wave-receiving entities, such as other vehicles, satellites, base stations, handheld devices, and more. The communication links include ground to air, air to ground, air to air, and ground to ground.

One of the characteristics of antenna transmission is “directivity,” which identifies the direction signals are transmitted to/received from the antenna. Low-angle communication, i.e., ground to ground, air to air, or ground/air to a satellite in low angle position, is most easily accomplished with radiating elements commonly called “monopoles” or “dipoles.” A dipole has two elements of equal size arranged in a shared axial alignment configuration with a small gap between the two elements. Each element of the dipole is fed with a charge 180 degrees out of phase from the other. In this manner, the elements will have opposite charges and common nulls. A monopole, in contrast, has only one element, but operates in conjunction with a ground plane, which mimics the missing second element. The physics of monopoles and dipoles are well known. Monopoles and dipoles radiate most of their energy in a direction that is perpendicular to their longitudinal axis and have very low or no radiation in a direction along their longitudinal axis. For this reason, monopoles and dipoles oriented perpendicular to the Earth's surface are suitable choices for communication that is substantially perpendicular to their longitudinal axis. However, for communication in directions nearing the axial direction of the monopole/dipole, these antennas are not good choices.

Another characteristic of antenna performance is “polarization,” which describes what physical plane the signal is being transmitted in. A dipole or monopole oriented in a particular position, e.g., vertical (perpendicular to the earth's surface), radiates signals with that same polarization, i.e., vertical. For a second antenna to receive maximum signal strength, it too must have the same physical orientation, i.e., vertical. In the case of two vertically-oriented antennas, as the receiving antenna is rotated away from vertical, its maximum receive power diminishes until the antenna reaches a horizontal orientation (perpendicular to the transmit antenna), at which time the maximum receive power reaches zero.

Satellites are transceivers that orbit the Earth and can relay communications back and forth from the Earth's surface or to other satellites, allowing communication virtually anywhere in the world. Because satellites orbit the earth and transmit to receivers in multiple directions and orientations, it is simply not possible, or at least, excessively difficult to guarantee that the antenna that is communicating with the orbiting satellite has a physical orientation that matches that of the satellite. For this reason, single-plane transmission with satellites is not practical. To solve this problem, satellites transmit signals in a “circular” polarization. In this manner, the signal is transmitted in a continuous right-hand rotating orientation.

A circularly polarized antenna has two dipoles arranged orthogonal to one another. The dipoles alternate “firing” with a positive charge rotating sequentially around the four individual elements and with a negative charge on its axially oppositely aligned second element. When viewed on a three-dimensional time vs. polarization graph, the circularly polarized signal resembles a helix.

The transmission path of the circularly polarized signal radiated from the two linear dipoles is substantially perpendicular to the intersecting axis of the crossed dipoles. In other words, the beam width of the crossed dipoles is relatively narrow. As the receiving antenna moves away from an angle perpendicular to the intersecting axis of the dipoles, its maximum receive power diminishes. This directionality is disadvantageous because, with satellite communication, the nearest satellite is always the one most directly above the antenna and the furthest satellites are the ones at low angles to the antenna. Coincidentally, this results in the strongest signal being sent to/from the closest satellite and the weakest signal being sent to/from the furthest satellites. This effect is amplified even greater in airborne applications where the antenna is moved even closer to the satellites directly above.

FIG. 1 shows one example of a prior-art antenna assembly 100 that includes both a crossed-dipole SATCOM antenna 102 as well as a linearly-polarized monopole antenna 104. The crossed-dipole SATCOM antenna 102 is used to communicate in a cross-polarized signal orientation with high-angle satellites. Because of the above-described directionality of the cross-polarized SATCOM antenna 102, the antenna 100 uses the monopole antenna 104 to communicate with low-angle receivers/transmitters, including satellites positioned at low angles. However, the SATCOM antenna 102 and the monopole antenna 104 are discrete elements that are separately controlled. Therefore, each antenna 102, 104 requires its own connector (not shown in this view) and/or a single connector with a switch selecting one or the other antenna 102, 104.

Because the antennas 102, 104 are separately fed, the prior-art antenna assembly 100 shown in FIG. 1 suffers from the disadvantage of requiring the user to switch from high-angle to low-angle mode. That is, if the assembly 100 is in high-angle mode, i.e., the SATCOM antenna 102 is being utilized, and a satellite is located at a low-elevation angle, the user will have to switch from high-angle coverage to low-angle coverage. Similarly, if the assembly 100 is in the low-angle coverage mode and a satellite is located at a high-elevation angle, the user will have to switch back to high-angle coverage.

FIG. 2 shows a prior-art antenna assembly 200 that includes a crossed-dipole SATCOM antenna 202 that, because of its shape, also serves as a circularly (linearly) polarized signal transmission antenna. The design was based on a Navy shipboard SATCOM antenna, whose elements are shaped like a loop and below it are four horizontal radials that served as the ground plane. These radials, however, are not needed when the antenna is installed on vehicles with a metallic groundplane. Because the antenna assembly 200 is provided with curved looping antenna elements 204a-d, this type of antenna is often referred to as an “egg beater” antenna. The purpose of the looping antenna elements 204a-d is to improve antenna coverage at low angles and even at the horizon. As FIG. 2 shows, each of the elements 204a-d curve from a horizontal to a vertical and back to a horizontal position. More specifically, each of the elements 204a-d has a portion 206a-d that is in a horizontal plane, a portion 208a-d that is in a vertical plane, and a portion 210a-d that is in a horizontal plane. Of course, each of the elements 204a-d has non-labeled portions between the labeled portions that are neither vertical nor horizontal.

Because each of the elements 204a-d has portions in both horizontal and vertical planes, the signals radiated by the elements 204a-d are launched in both the vertical and horizontal planes as well as in between. Advantageously, the egg beater antenna allows a single connector to be used to communicate in both low and high angle mode (the vertical and horizontal planes.)

With regard to communication, current satellites are enabled through the Ultra High Frequency Follow-On (UFO) System, which is a United States Department of Defense (DOD) program sponsored and operated by the U.S. Navy. The UFO system provides communications for airborne, ship, submarine and ground forces via a constellation of eleven satellites operating in the UHF frequency range. Under this system, reception occurs in the frequency range of 243-270 MHz and transmission occurs in the range of 290-320 MHz.

The Mobile User Objective System (MUOS) is also a UHF system primarily serving the DOD. The MUOS will replace the legacy UFO system before that system reaches its end of life and will provide users with new capabilities and enhanced mobility, access, capacity, and quality of service. The MUOS will operate as a global cellular service provider to support the war fighter with modern cell phone-like capabilities, such as multimedia. It converts a commercial third generation (3G) Wideband Code Division Multiple Access (WCDMA) cellular phone system to a military UHF SATCOM radio system using geosynchronous satellites in place of cell towers. The MUOS frequency range, however, is not the same as that of the UFO system. Specifically, the MUOS operates at 280-322 MHz for the transmission mode and 338-380 MHz for the reception mode. By operating in these frequency bands, a lower frequency band than that used by conventional terrestrial cellular networks, both the UFO and MUOS provide warfighters with the tactical ability to communicate in “disadvantaged” environments, such as heavily forested regions where higher frequency signals would be unacceptably attenuated by the forest canopy.

Currently, because the UHF system is scheduled to soon be phased out and replaced with the MUOS, potential purchasers of SATCOM antennas and related equipment are hesitant to purchase components that are designed to only operate on the UHF system. On the other hand, they are not yet willing to purchase components that are designed to only operate on the MUOS, because communication on the UHF system is still needed. A third option is to purchase components that are able to operate on both systems. For antennas, this requires broadband frequency tuning that covers the communication range of both systems. As is known in the art, however, increasing the communication frequency range brings with it the trade-off of decrease in performance.

Accordingly, a need exists to overcome the above-described shortcomings with the prior art.

### SUMMARY OF THE INVENTION

The invention provides an inverted-u crossed-dipole SATCOM antenna that overcomes the hereinafore-mentioned disadvantages of the heretofore-known devices and methods of this general type and that provides improved radiation patterns and physical assembly advantages, as described herein.

Briefly, in accordance with the present invention, disclosed is an antenna assembly that includes an antenna assembly that has an antenna/radio interface, a body section connected to the antenna/radio interface, and a group of omnidirectional radiating elements, where each radiating element has a first portion with a first end and a second end, the first end being coupled to the body section and the second end being opposite the first end. Each element also has a second portion with a first end, a second end, and a linear section between the first end and the second end, the first end of the second portion being coupled to the second end of the first portion and the second end of the second portion being opposite the first end of the second linear portion. Additionally, each element is arranged so that the first portion of each element is substantially coaxially aligned with the first portion of at least one other element in the group of omnidirectional radiating elements and substantially orthogonal to the first portion of at least two other elements in the group of omnidirectional radiating elements and the linear section of each second portion is parallel with the linear section of each other element in the group of omnidirectional radiating elements, wherein the first portion and the second portion meet at a non-zero angle to each other.

In one embodiment of the present invention, the first portion defines a first plane and the second portion defines a second plane, wherein the first plane is non-parallel to the second plane.

In an exemplary embodiment of the present invention, each first portion and the linear section of each second portion includes a substantially planar conductive surface.

In accordance with yet another embodiment of the present invention, the body section includes an elongated section with a first end a second end, where the antenna/radio interface is coupled to the first end of the elongated section and the group of omnidirectional radiating elements is connected at the second end of the elongated section.

In accordance with an additional embodiment of the present invention, the body section includes a balun coupled to the elongated section.

In accordance with one more embodiment of the present invention, an impedance-matching network is electrically coupled between the antenna/radio interface and the group of omnidirectional radiating elements.

In accordance with a further embodiment of the present invention, a 90° hybrid is electrically coupled between the antenna/radio interface and the group of omnidirectional radiating elements.

In accordance with another embodiment of the present invention, at least a portion of one of the first portion and the second portion of the group of omnidirectional radiating elements is formed on a printed circuit board.

In accordance with other embodiments of the present invention, the second end of the second portion is spaced away from the body section by a distance.

In accordance with yet another embodiment, the present invention includes a first impedance-matching network tuned to a first frequency band and electrically coupled between the antenna/radio interface and the group of omnidirectional radiating elements, a second impedance-matching network tuned to a second frequency band, different from the first frequency band, and electrically coupled between the antenna/radio interface and the group of omnidirectional radiating elements, and a switch selectable between the first impedance-matching network and the second impedance-matching network.

In accordance with a further embodiment, the present invention includes a normally-selected first switching state, a selectable second switching state different from the first switching state, and a switching element physically movable to permanently select the second switching state. The switching element can be accessible from an exterior of the antenna assembly.

In accordance with another embodiment of the present invention, each radiating element further includes a third portion with a first end and a second end, the first end of the third portion being coupled to the second end of the second portion and the second end of the third portion being opposite the first end of the third portion, wherein the third portion and the second portion meet at non-zero angle to each other and wherein the first portion, the second portion, and the third portion each lie in a plane, wherein each plane is different from the other

In further embodiments of the present invention, the antenna assembly includes an elongated body having a first end and a second end opposite the first end, an upper element-supporting portion physically coupled to the first end of the elongated body and supporting a first portion of each of four elements, the first portion of each element being aligned substantially coaxially with the first portion of at least one other of the four elements and substantially orthogonal to the first portion of at least two other of the four elements, and a lower element-supporting portion coupled to the upper element-supporting portion and supporting a second portion of each of the four elements, the second portion of each of the four elements having a substantially linear portion and wherein the first portion and the second portion of each element are conductively coupled.

In accordance with still another embodiment, the present invention includes an antenna/radio interface coupled to the elongated body, a first impedance-matching network tuned to a first frequency band and electrically coupled between the antenna/radio interface and the four omnidirectional radiating elements, a second impedance-matching network tuned to a second frequency band, different from the first frequency band, and electrically coupled between the antenna/radio interface and the four omnidirectional radiating elements, and a switch selectable between the first impedance-matching network and the second impedance-matching network.

Although the invention is illustrated and described herein as embodied in an inverted-u crossed-dipole SATCOM antenna, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention, in which:

FIG. 1 is a perspective view of a prior-art crossed dipole/monopole antenna.

FIG. 2 is a perspective view of a prior-art crossed dipole “eggbeater” antenna.

FIG. 3 is a perspective view of a crossed dipole SATCOM antenna according to an embodiment of the present invention.

FIG. 4 is a graphical representation of a representative radiation pattern of the inventive antenna assembly when looking directly down a longitudinal axis of the elongated body section according to an embodiment of the present invention.

FIG. 5 is a graphical representation of a representative radiation pattern of the inventive antenna assembly when looking at the antenna perpendicular to a longitudinal axis of the elongated body section according to an embodiment of the present invention.

FIG. 6 is a perspective view of a crossed dipole SATCOM antenna with a PCB upper portion and tubular lower radiators according to an embodiment of the present invention.

FIG. 7 is a perspective view of a “lamp-shade” type crossed dipole SATCOM antenna with PCB upper and lower portions according to an embodiment of the present invention.

FIG. 8 is a functional block diagram illustrating electrical components of the inventive antenna assembly according to an embodiment of the present invention.

FIG. 9 is a perspective view of a crossed dipole SATCOM antenna according to an embodiment of the present invention.

FIG. 10 is a perspective view of a crossed dipole SATCOM antenna according to an embodiment of the present invention.

FIG. 11 is a set of graphs illustrating a 90° phase difference between the two dipoles of the inventive antenna assembly according to an embodiment of the present invention.

FIG. 12 is a graph combining the two graphs of FIG. 11 and showing the circularly polarized radiation pattern of the inventive antenna assembly according to an embodiment of the present invention.

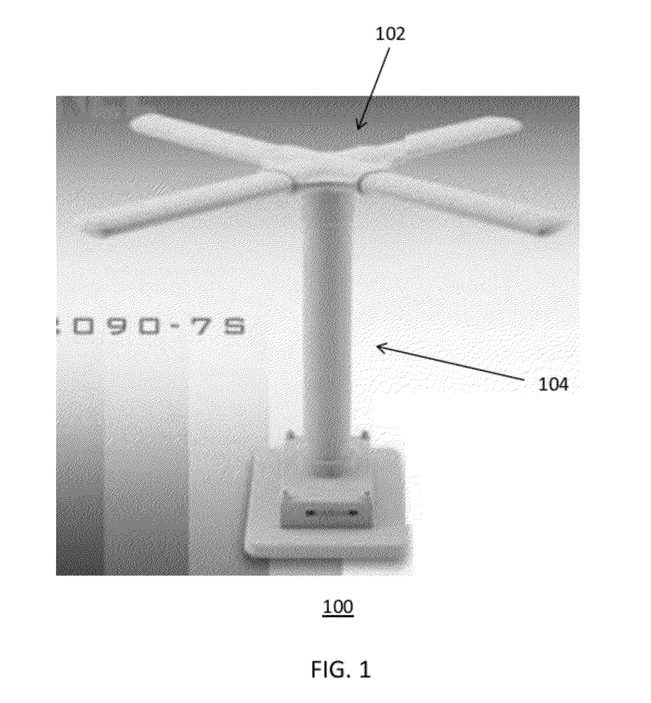

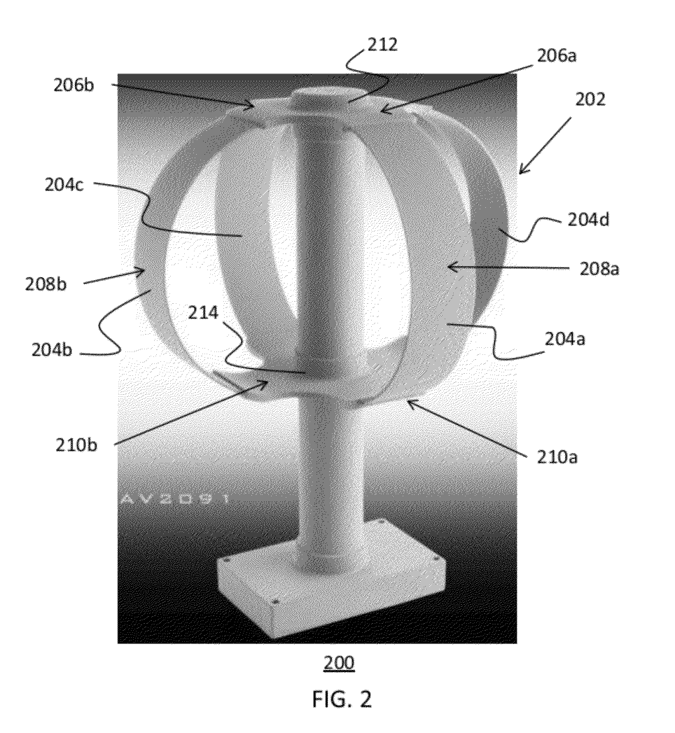

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention, according to an embodiment, overcomes problems with the prior art by providing an antenna assembly with a single connector, that efficiently communicates in simultaneous high-angle and low-angle modes, and is simple and inexpensive to manufacture.

Described now is an antenna configuration, according to an exemplary embodiment of the present invention. The present invention is a cross polarized SATCOM antenna assembly that includes a set of inverted U-shaped radiating and receiving elements coupled to and fed from an elongated body. The present invention can be used to communicate with satellites, regardless of their relative position to the inventive antenna assembly. The antenna assembly includes a set of two or more discrete orthogonal dipole elements that can be formed from a set of individual conductors coupled to a central feed point or can be etched on a circuit board or other suitable organic or inorganic medium. The orthogonal dipole elements are excited by a signal fed from a 90° hybrid and a feed network and matching circuitry. Additionally, the angle in which the discrete conductors of the inventive antenna assembly are coupled to each other advantageously provides a superior radiation pattern for SATCOM communication.

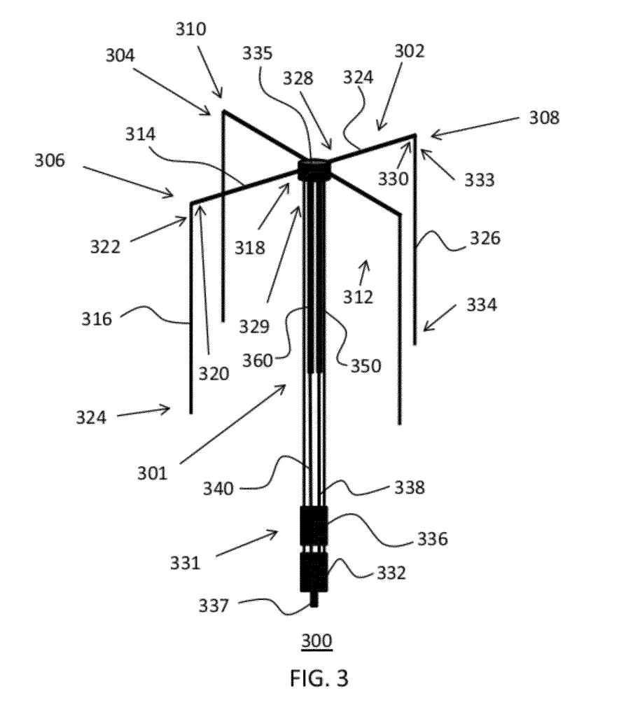

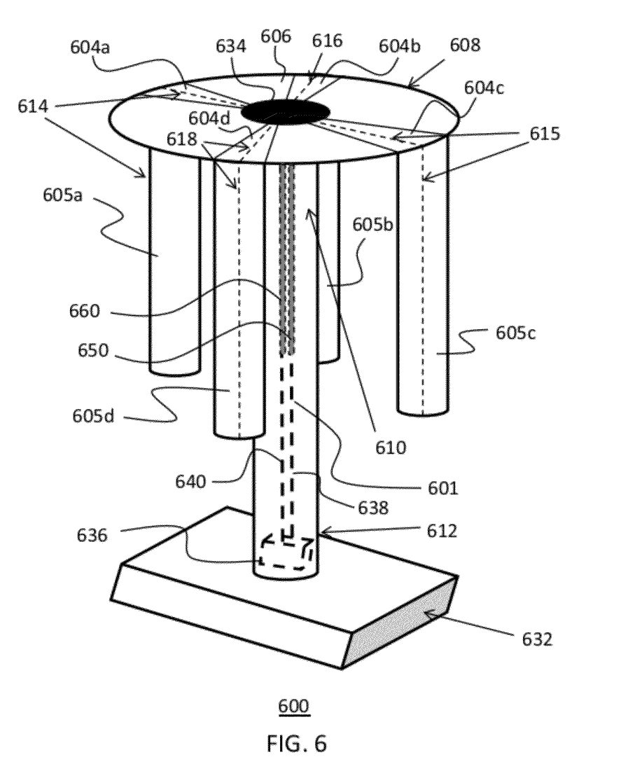

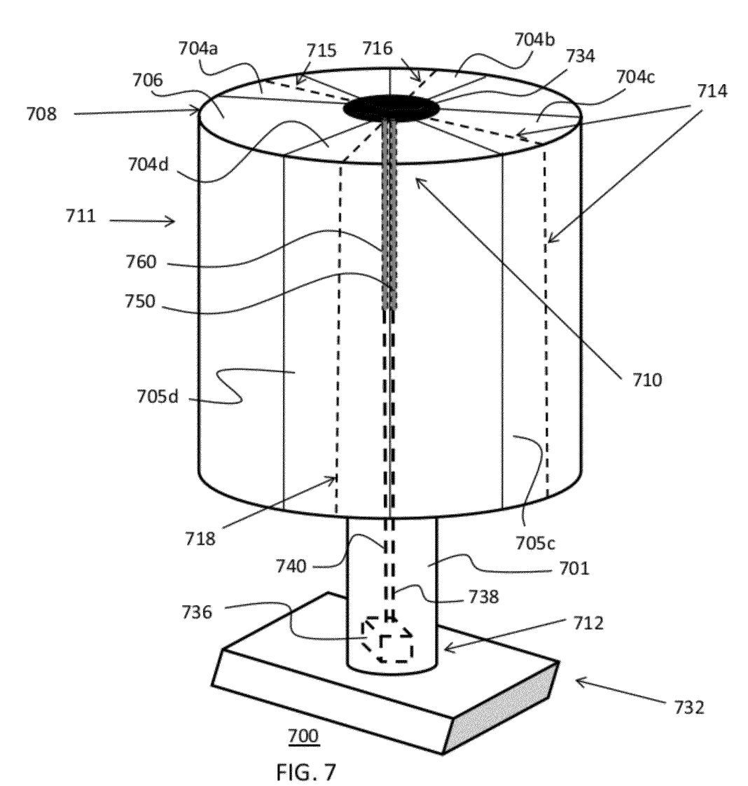

With reference to FIG. 3, an embodiment of the presently inventive antenna assembly 300 is shown in an elevated perspective view. The inventive antenna assembly 300 includes a pair of orthogonal dipole elements 302, 304. Dipoles are known in the art and consist of a pair of monopoles axially aligned with one another and each fed with a charge of opposite polarity from that of the other. In the embodiment shown in FIG. 3, each one of the pair of orthogonal dipole elements 302, 304 is formed from a co-linear or co-axial arrangement of two monopoles. More specifically, the first orthogonal dipole 302 is formed from a first monopole 306 and a second monopole 308. Similarly, the second orthogonal dipole 304 is formed from a third monopole 310 and a fourth monopole 312. As shown in the view of FIG. 3, and as in actual practice, the two dipoles 302 and 304 are arranged so that at least a portion of each is orthogonal to the other. The elements can take many shapes and the present invention is not limited to those shown in FIG. 3. In fact, as will be discussed below, FIGS. 6 and 7 provide two alternative shapes.

Also illustrated in the embodiment shown in FIG. 3, each of the monopoles 306, 308, 310, 312 is formed from two discrete, i.e., individually distinct, linear portions that are coupled together at a non-zero angle from the other. More specifically, the first monopole 306 is formed from a first linear portion 314 and a second linear portion 316. The first linear portion 314 has a first end 318 and a second end 320 and the second linear portion 316 has a first end 322 and a second end 324. The second end 320 of the first linear portion 314 is fixedly and electrically communicatively coupled to the first end 322 of the second linear portion 316. In the particular embodiment shown in FIG. 3, the first linear portion 314 is at an approximately 90° angle to the second linear portion 316. It should be noted that the first linear portion 314 and the second linear portion 316 can be arranged at any non-zero angle, i.e., anywhere between 0 to 180°, non-inclusive of the limits.

Similarly, the second monopole 308 is formed from a first linear portion 324 and a second linear portion 326. The first linear portion 324 has a first end 328 and a second end 330 and the second linear portion 326 has a first end 333 and a second end 334. The second end 330 of the first linear portion 324 is fixedly and electrically communicatively coupled to the first end 333 of the second linear portion 326. In the particular embodiment shown in FIG. 3, the first linear portion 324 is at an approximately 90° angle to the second linear portion 326.

Although not labeled, the third monopole 310 and the fourth monopole 312 have structures similar to the first 306 and second monopoles 308. In particular, the third monopole 310 and the fourth monopole 312 are each defined by two discrete linear element portions.

Focusing still on FIG. 3, the inventive antenna assembly 300 also includes an elongated body section 301. The elongated body section 301 physically supports the pair of orthogonal dipole elements 302, 304 as well as several electrical components that allow the pair of orthogonal dipole elements 302, 304 to radiate radiofrequency (RF) communication waves efficiently and in a circularly-polarized manner.

The elongated body section 301 includes a first end 329 and a second end 331. The first end of each of the first portions of the four monopoles forming the orthogonal dipole elements 302, 304 are supported at the first end 329 of the elongated body section 301. The second end 331 of the elongated body section 301 features an antenna/radio interface 332 that provides connectivity to a transmitter/receiver. In particular, the antenna/radio interface 332 includes a connector 337 that allows a radio to be attached to the antenna assembly 300. Examples of connector types known in the industry are BNC, TNC, N-Type, and SMA. Other types of connectors are contemplated and may be used without departing from the true spirit and scope of the invention.

Also, according to an embodiment of the present invention, for the most efficient radiation and reception of RF signals, an impedance matching circuit 335 is provided between the radio/antenna interface (RF connector) 332 and the orthogonal dipole elements 302, 304. The function of the impedance matching network 335 is to “match” the antenna impedance of each element to the impedance of the propagating medium, which is usually air or free space. The impedance matching network 335 connects and feed signals to the dipole elements 302, 304. Impedance matching network 335 includes inductive and capacitive elements, which are well known in the art. Therefore, impedance matching and particulars of such circuits will not be further discussed herein.

Additionally, located between the impedance matching network 335 and the radio/antenna interface 332 is a 90° quadrature hybrid 336. Quadrature hybrids are circuits that separate a single input signal into two output signals with a relative phase difference, in this case, 90°. Although particular embodiments of the present invention place the quadrature hybrid 336 at the second end 331 of the elongated body 301, the invention is not limited to any particular placement of the quadrature hybrid 336. Hybrids are well known in the art. Therefore, terminations, hybrids, and particulars of such circuits will not be further discussed herein. In the present invention, a signal received from a radio is fed into the hybrid 336 and is then, in turn, fed to the dipoles 302, 304.

As is known in the art, the length of the dipoles is dependent on the intended frequency range of the antenna. Typically, elements are chosen to be ¼ or ⅛ of a wavelength of the center frequency within a band of intended frequencies. The present invention is intended to be operated in the SATCOM frequency range, which includes a transmission channel in the frequency range of 280-322 MHz and a reception channel in the frequency range of 338-380 MHz.

When the dipoles 302, 304 are energized with a varying voltage signal, electromagnetic energy is radiated from the dipoles 302, 304 (or, in the alternative, the electromagnetic energy is collected by it) forming an antenna to enable wireless communication. As is understood in the relevant arts, the receive and transmit characteristics of RF antennas are essentially identical. It is therefore understood that references to or descriptions of either one of the receive or the transmit characteristics of an antenna apply to both the receive and transmit characteristics of that antenna.

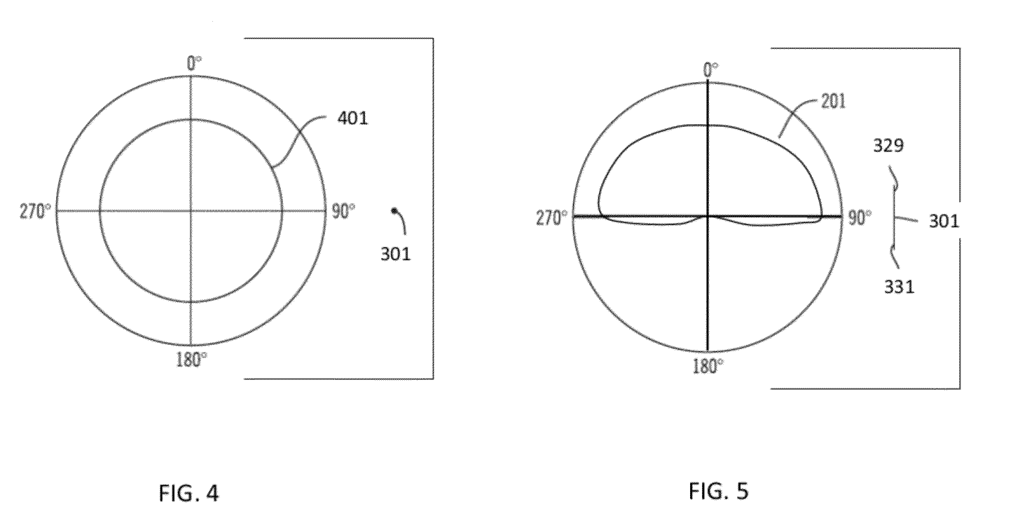

For illustrative purposes, a radiation pattern 401 of an embodiment of the inventive antenna assembly 300 of FIG. 3, is shown in FIGS. 4 & 5. FIG. 4 shows the pattern 401 of the antenna assembly 300 from an axial end view. FIG. 5 shows the pattern of the inventive antenna assembly 300 viewed from an elevational side view with the first end 329 of the elongated body section 301 oriented in a direction toward 0 degrees and the second end 331 of the elongated body section 301 oriented in a direction toward 180 degrees. Although the patterns would be produced by the antenna assembly 300 being at the center of the graphs, for illustrative purposes, a dot depicting the orientation of the antenna assembly 300 is pictured on the right side of FIG. 4 and a line depicting the orientation of the antenna assembly 300 is pictured on the right side of FIG. 5.

Continuing further, FIG. 4 illustrates the top-view radiation pattern 401, referred to as “omnidirectional”, of the inventive antenna assembly 300. In the perspective of FIG. 4, looking down the axis of the elongated member 301, the radiation pattern is substantially uniform throughout all angles. In this mode, the antenna communicates equally well in all lateral directions. As previously stated, FIG. 5 shows inventive antenna assembly 300 from a side view. This view shows that radiation strength, also called “gain,” is fairly consistent from approximately 90° to approximately 270°.

When placed in an orthogonal orientation, as shown in FIG. 3, the first monopole portions 310, 312, 314, 324 of the two orthogonal dipoles 302 and 304 alternate “firing” with a positive charge rotating sequentially around the four individual first monopole portions and a negative charge on their axially opposing element. Therefore, each dipole 302 and 304, alternately and continuously reverses polarization.

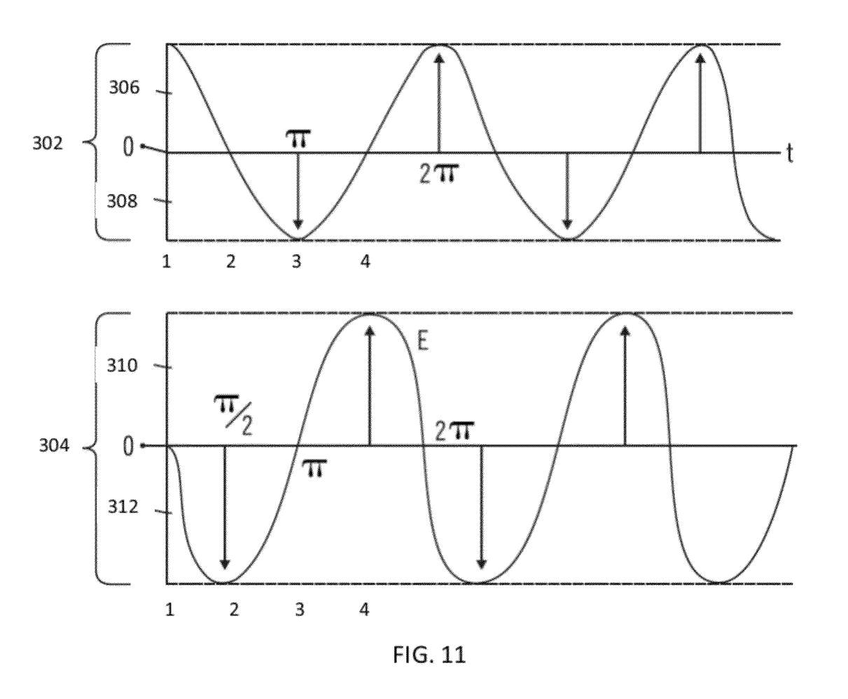

FIG. 11 shows a graph of an electric field emitted from dipole 302, which includes monopoles 306 and 308, versus time. Also shown in FIG. 11 is a graph of an electric field emitted from dipole 304, which includes monopoles 310 and 312, versus time. A signal that is fed through the connector 337 will pass through the hybrid 336 and then to the elements. Comparing the two graphs, it can be seen at any given time, that the dipoles 302 and 304 are always 90° out of phase. This phase difference is the product of the input signal routed through the 90° hybrid 336 that splits the input signal into two separate signals, a first sent down transmission line 338 and a second down transmission line 340, with a phase difference of 90°. The result is a positive charge that continuously rotates around the elements.

Specifically, and with reference to the element placement shown in FIG. 3, at a given time 1, a positive charge is applied to element 306 and a negative charge of equal magnitude will be applied to element 308. At time 2, a positive charge will be applied to element 312 and a corresponding negative charge to element 310. At time 3, a positive charge will be applied to element 308, with the corresponding negative charge applied to element 306. Finally, to complete one rotation, a positive charge is applied to element 310 and a corresponding negative charge is applied to element 312. In this manner, a positive charge can be visualized rotating around the circumference of the antenna, in the order 306, 312, 308, and 310.

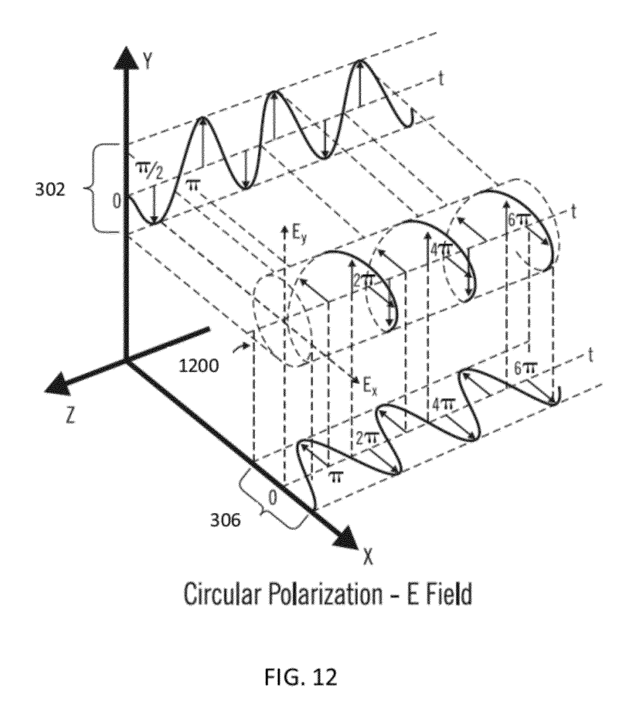

Turning now to FIG. 12, a graph combining the two graphs of FIG. 11 and showing the resulting circularly-polarized wave produced by the radiating fields of the two orthogonal elements 302 and 304 is illustrated. In this exemplary embodiment, one of the dipoles 302 is oriented along the Y-axis and the other dipole 306 is oriented along the X-axis, the electric fields E_{y} and Ex, respectively, of the two dipoles 302 and 306 add to produce a circularly polarized radiation pattern 1200 that resembles a helix. The result is that, irregardless of the orientation of a second antenna, either omni directional or cross-polarized, reception will be possible at least a portion of each period, 2 times phi (II).

Referring briefly back to FIG. 3, connecting the 90° quadrature hybrid 336 and the feed network/matching circuit 335 is two lengths of transmission line 338 and 340, which are preferably semi-rigid coaxial cables, such as part number UT-085, available from Micro-Coax, Inc. at 206 Jones Blvd. Pottstown, Pa. 19464-3465. The transmission lines 338 and 340 are conductive pathways that are insulated from and run within an outer conducting jacket. Coaxial cables are advantageous because they provide high levels of isolation to the signal-carrying center conductors by prevent stray electromagnetic signals from entering or exiting the conductors. Semi-rigid cables also offer the advantage of solderability to their outer jackets. The metallic outer jackets, usually made of aluminum or copper, can be securely affixed to a supporting material by soldering or spot-welding the jacket surface. The center conductor and jacket are isolated from each other by a dielectric insulating material that runs throughout the length of the cable.

Also attached to the feed network/matching circuit 335 and then to the jacket of the transmission lines 338 and 340 is a balun assembly that includes a set of baluns 350 and 360. In an exemplary embodiment, the baluns are each a quarter wavelength long at the center frequency, for example, 7.3 inches in length. Other lengths have been shown to be used advantageously with the present invention. Baluns are well known in the art as a way of reducing the voltage standing wave ratio (VSWR) on the transmission lines. Therefore, there is no need to describe any further details of baluns herein.

Referring now to FIG. 6, the dipoles 302 and 304 (previously shown in FIG. 3) are realized, at least in part, by etching or otherwise placing metallic areas 604a-d on a circuit-supporting dielectric material 606. A few exemplary dielectric materials are fiberglass, plastic, and RT/Duroid, among others. The conductive metallic areas 604a-d form portions of radiating elements and can be any metallic material or a combination of various metallics, including both organic and inorganic materials suitable for radiating and receiving electromagnetic energy. The purpose of the dielectric material 606 is to provide support for the layer of conductive metallic areas 604a-d attached to the dielectric material 606 so that the circuit will maintain its shape and dimensional relationship to other components. In addition, the circuit can be placed inside or on protective structures. One type of protective cover for antennas is what is commonly called a “radome.” Radomes and radome materials are well known in the art.

To provide improved low-angle radiation/reception, the antenna 600 shown in FIG. 6 is provided with a plurality of radiators 605a-d, each electrically communicatively coupled to a corresponding one of the conductive metallic areas 604a-d. By comparison, the conductive metallic areas 604a-d of the inventive antenna shown in FIG. 6 are analogous to the first linear portion 314 of the embodiment shown in FIG. 3. Likewise, the radiators 605a-d of the inventive antenna shown in FIG. 6 are analogous to the second linear portion 316 of the embodiment shown in FIG. 3. Therefore, each coupling of the two discrete components, i.e., the conductive metallic area 604 and radiator 605, creates a working monopole. More specifically, metallic area 604a and radiator 605a creates a first monopole, metallic area 604b and radiator 605b creates a second monopole, metallic area 604c and radiator 605c creates a third monopole, and metallic area 604d and radiator 605d creates a fourth monopole.

As shown in FIG. 6, a first one 604a of the conductive metallic areas 604a-d is substantially coplanar and axially aligned with a third one 604c of the conductive metallic areas 604a-d. Similarly, a second one 604b of the conductive metallic areas 604a-d is substantially coplanar and axially aligned with a fourth one 604d of the conductive metallic areas 604a-d.

Each pair of opposing metallic areas, i.e., 604a & 604c and 604b and 604d, along with their respective radiators, i.e., 605a & 605c and 605b & 605d, respectively, creates a dipole. Specifically, metallic area 604a and the electrically communicatively coupled radiator 605a forms a first monopole 614 (shown as an imaginary dotted line in FIG. 6). Opposing the first monopole 614 is a second monopole 615 (shown as an imaginary dotted line in FIG. 6) formed from metallic area 604c and the electrically communicatively coupled radiator 605c. Together, the first monopole 614 and the second monopole 615 form a first dipole.

Similarly, metallic area 604b and the electrically communicatively coupled radiator 605b form a third monopole 616 (shown as an imaginary dotted line in FIG. 6). Opposing the third monopole 616 is a fourth monopole 618 (shown as an imaginary dotted line in FIG. 6) formed from metallic area 604d and the electrically communicatively coupled radiator 605d. Together, the third monopole 616 and the fourth monopole 618 form a second dipole. As FIG. 6 shows, a line passing through the metallic areas 604a & 604c of the first dipole and a line passing through the metallic areas 604b & 604d of the second dipole are substantially orthogonal to each other. As FIG. 6 also shows, the radiators 605a-d are illustrated as tubular structures that are all substantially parallel to one another. The invention, however, is not so limited and, in accordance with embodiments of the present invention, the radiators 605a-d can be any shape of structure that is able to radiatively communicate RF waves with the conductive metallic areas 604a-d. In one embodiment, the conductive metallic areas 604a-d extend to and over the outer edge 608 of the dielectric material 606, where the conductive metallic areas 604a-d are then electrically coupled to the radiators 605a-d through, for instance, soldering. In another embodiment, each of the conductive metallic areas 604a-d includes a thru-hole that is then electrically coupled to a corresponding one of the radiators 605a-d. As should now be clear, the invention is in no way limited to any particular measures for electrically coupling the conductive metallic areas 604a-d to the radiators 605a-d.

Focusing still on FIG. 6, the inventive antenna assembly 600 also includes an elongated body section 601. The elongated body section 601 has a first end 610 that physically supports the circuit-supporting dielectric material 606 which, in turn, supports the conductive metallic areas 604a-d and the radiators 605a-d. The elongated body section 601 includes a second end 612 that features an antenna/radio interface 632.

The antenna/radio interface 632 includes a connector (not shown) that allows a radio to be attached to the antenna assembly 600. Examples of connector types are BNC, TNC, N-Type, and SMA. Other types of connectors are contemplated and may be used without departing from the true spirit and scope of the invention.

Also, according to an embodiment of the present invention, for the most efficient radiation and reception of RF signals, an impedance matching circuit 634 is provided between the radio/antenna interface (RF connector) 632 and the conductive metallic areas 604a-d.

Located between the impedance matching network 634 and the radio/antenna interface 632 is a 90° quadrature hybrid 636. A signal received from a radio is fed into the hybrid 636 and is then, in turn, led to the dipoles created by the conductive metallic areas 604a-d and their associated radiators 605a-d. When the conductive metallic areas 604a-d and their associated radiators 605a-d are energized with a varying voltage signal, electromagnetic energy is radiated from the conductive material (or in the alternative, the electromagnetic energy is collected with it) forming an antenna to enable wireless communication.

Connecting the 90° quadrature hybrid 636 and the feed network/matching circuit 634 is two lengths of transmission line 638 and 640, which are preferably semi-rigid coaxial cables. Also attached to the feed network/matching circuit 634 and then to the jacket of the transmission lines 638 and 640 is a balun assembly that includes a set of baluns 650 and 660. In an exemplary embodiment, the baluns 650 and 660 are each a quarter wavelength long at the center frequency, but other lengths have been shown to be used advantageously with the present invention. Baluns are well known in the art as a way of reducing the voltage standing wave ratio (VSWR) on the transmission lines. Therefore, there is no need to describe any further details of baluns herein.

Referring now to FIG. 7, the dipoles 302 and 304 (previously shown in FIG. 3) are realized by etching or otherwise placing metallic areas 704a-d on a circuit-supporting dielectric material 706. In addition to having the disc-like shape exemplified by the circuit-supporting dielectric material 606 shown in FIG. 6, the circuit-supporting dielectric material 706 of FIG. 7 includes a portion that forms a sidewall 711 surrounding and attached to a periphery of the circuit-supporting dielectric material 706. The circuit-supporting dielectric material 706 and the sidewall 711 somewhat resemble a lamp shade shape.

The conductive metallic areas 704a-d form portions of radiating elements and can be any metallic material or a combination of various metallics, including both organic and inorganic materials suitable for radiating and receiving electromagnetic energy. Once again, the purpose of the dielectric material 706 is to provide support for the layer of conductive metallic areas 704a-d attached to the dielectric material 706 so that the circuit will maintain its shape and dimensional relationship to other components. However, in the embodiment of FIG. 7, additional conductive metallic areas 705a-d form a set of radiators on the sidewall 711. In the perspective downward looking view of FIG. 7, only radiators 705c and 705d can be seen.

In accordance with an embodiment of the present invention, the upper dielectric material 706 and/or the sidewall 711 can be part of a radome structure. In this embodiment, the conductive metallic areas 704a-d and 705a-d can be formed on an inside surface, an exterior surface, or between layers of, for example, fiberglass, forming a protective radome structure.

Cooperation between the metallic areas 704a-d and 705a-d advantageously provides both low-angle and high-angle radiation/reception. By comparison, the conductive metallic areas 704a-d of the inventive antenna shown in FIG. 7 are analogous to the first linear portion 314 of the embodiment shown in FIG. 3. Likewise, the radiators 705a-d of the inventive antenna shown in FIG. 7 are analogous to the second linear portion 316 of the embodiment shown in FIG. 3. Therefore, each pair of conductive metallic area 704 and radiator 705 creates a monopole. More specifically, metallic area 704a and radiator 705a creates a first monopole, while metallic area 704b and radiator 705b creates a second monopole, metallic area 704c and radiator 705c creates a third monopole, and metallic area 704d and radiator 705d creates a fourth monopole.

As in the embodiment shown in FIG. 6, a first one 704a of the conductive metallic areas 704a-d is substantially coplanar and axially aligned with a third one 704c of the conductive metallic areas 704a-d. Similarly, a second one 704b of the conductive metallic areas 704a-d is substantially coplanar and axially aligned with a fourth one 704d of the conductive metallic areas 704a-d. As used herein, the term “axially aligned” generally refers to a relationship where a longitudinal axis of a centerline of one element is aligned with the longitudinal axis of the centerline of another element.

Each pair of opposing metallic areas, i.e., 704a & 704c and 704b and 704d, along with their respective radiators, i.e., 705a & 705c and 705b & 705d, creates a dipole. Specifically, metallic area 704c and the electrically communicatively coupled radiator 705c forms a first monopole 714 (shown as an imaginary dotted line in FIG. 7). Opposing the first monopole 714 is a second monopole 715 (shown as an imaginary dotted line in FIG. 7) formed from metallic area 704a and the electrically communicatively coupled radiator 705c (not visible in the view of FIG. 7). Together, the first monopole 714 and the second monopole 715 form a first dipole.

Similarly, metallic area 704b and the electrically communicatively coupled radiator 705b (not visible in this view) form a third monopole 716 (shown as an imaginary dotted line in FIG. 7). Opposing the third monopole 716 is a fourth monopole 718 (shown as an imaginary dotted line in FIG. 7) formed from metallic area 704d and the electrically communicatively coupled radiator 705d. Together, the third monopole 716 and the fourth monopole 718 form a second dipole. As FIG. 7 shows, a line passing through the metallic areas 704a & 704c of the first dipole and a line passing through the metallic areas 704b & 704d of the second dipole are substantially orthogonal to each other.

In the embodiment shown in FIG. 7, each radiator 705a-d formed on the side wall 711 is linear in shape. That is, a portion of the conductive material forming the radiators falls within a straight line. It should be noted that the invention is not limited to the embodiments shown. In accordance with other embodiments of the present invention, the radiators 704a-d and 705a-d can be any shape or structure that is able to radiatively communicate RF waves. In one embodiment, the conductive metallic areas 704a-d extend to and over the outer edge 708 of the dielectric material 706, where the conductive metallic areas 704a-d are then electrically coupled to the radiators 705a-d through, for instance, soldering or continuous folded conductive areas/pathways. As should now be clear, the invention is in no way limited to any particular measures for electrically coupling the conductive metallic areas 604a-d to the radiators 605a-d.

In addition, the sidewall 711 surrounding and attached to the periphery of the circuit-supporting dielectric material 706 can be filled with various materials to provide strength and durability. For instance, the sidewall 711 can surround a foam material that is lightweight and provides sufficient strength and support for the sidewall 711.

Focusing still on FIG. 7, the inventive antenna assembly 700 also includes an elongated body section 701. The elongated body section 701 has a first end 710 that physically supports the circuit-supporting dielectric material 706 which, in turn, supports the conductive metallic areas 704a-d and the radiators 705a-d. The elongated body section 701 includes a second end 712 that features an antenna/radio interface 732.

The antenna/radio interface 732 includes, in accordance with an embodiment of the present invention, a connector (not shown) that allows a radio to be attached to the antenna assembly 700. Examples of connector types are BNC, TNC, N-Type, and SMA. Other types of connectors are contemplated and may be used without departing from the true spirit and scope of the invention.

Also, according to an embodiment of the present invention, for the most efficient radiation and reception of RF signals, an impedance matching circuit 734 is provided between the radio/antenna interface (RF connector) 732 and the conductive metallic areas 704a-d.

Located between the impedance matching network 734 and the radio/antenna interface 732 is a 90° quadrature hybrid 736. A signal received from a radio is fed into the hybrid 736 and is then, in turn, led to the dipoles created by the conductive metallic areas 704a-d and their associated radiators 705a-d. When the conductive metallic areas 704a-d and their associated radiators 705a-d are energized with a varying voltage signal, electromagnetic energy is radiated from the conductive material (or in the alternative, the electromagnetic energy is collected with it) forming an antenna to enable wireless communication.

Connecting the 90° quadrature hybrid 736 and the feed network/matching circuit 734 is two lengths of transmission line 738 and 740, which are preferably semi-rigid coaxial cables. Also attached to the feed network/matching circuit 734 and then to the jacket of the transmission lines 738 and 740 is a balun assembly that includes a set of baluns 750 and 760. In an exemplary embodiment, the baluns are each 7.3 inches in length, but other lengths have been shown to be used advantageously with the present invention. Baluns are well known in the art as a way of reducing the voltage standing wave ratio (VSWR) on the transmission lines. Therefore, there is no need to describe any further details of baluns herein.

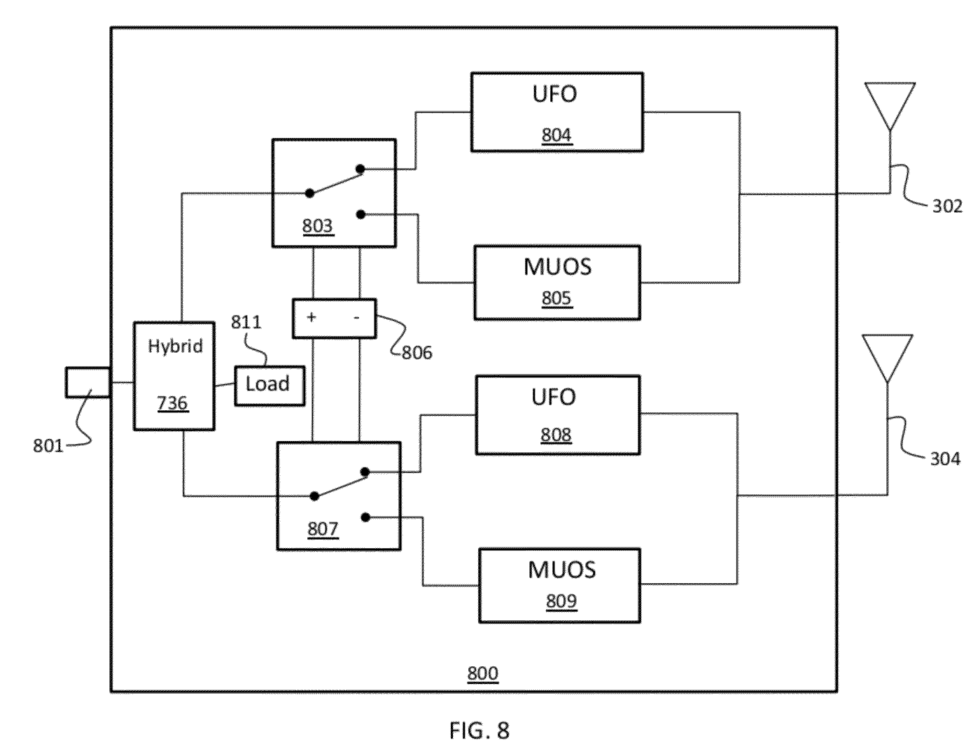

Referring now to FIG. 8, a further feature, in accordance with the present invention, is illustrated in a schematic view. As mentioned above, the current UFO system is being actively utilized but is scheduled to become obsolete in the very near future. Replacing the UFO system will be the MUOS. Because the UHF system is scheduled to soon be phased out and replaced with the MUOS, potential purchasers of SATCOM antennas and related equipment are hesitant to purchase components that are designed to only operate on the UHF system and are not yet able to purchase components that are designed to operate only on the MUOS. Therefore currently-available satellite antennas should have the ability to communicate with both the UFO system and the MUOS. One way of accomplishing this is to provide an impedance matching network with a wide band of frequencies. However, as the matched frequency band increases, efficiency decreases. Therefore, as illustrated in FIG. 8, the present invention advantageously provides two separate matching networks, each tasked with impedance matching a narrow band of frequencies.

More specifically, with reference to a transmission mode, a signal is input into coaxial connector 801 and is fed to the 90-degree hybrid 736. The hybrid has three outputs, two of which go to switches 803, 807, and one of which is termination into a load, e.g., 50 Ohms. The switches 803, 807 can be, for example, coaxial switches. Looking first to switch 803, the switch directs the signal to one of two available impedance matching networks—a UFO matching network 804 or a MUOS matching network 805. Each of the networks 804, 805 is responsible for impedance matching the signal only within its assigned bandwidth. Therefore, each network 804, 805 is more efficient than a single network able to impedance match a bandwith that spans both the UFO and MUOS frequency bands. Once the signals pass through the selected impedance matching network, they are routed to one of the dipoles of the inventive antenna, for example, dipole 302 of FIG. 3. It should be noted that the switch 803 can be any switching device.

Similarly, switch 807 directs the signal to one of two other available impedance matching networks—UFO matching network 808 or MUOS matching network 809. Again, each of the networks 808, 809 is responsible for impedance matching the signal only within its assigned bandwidth. Once the signals pass through the selected impedance matching network, they are routed to one of the dipoles of the inventive antenna, for example, dipole 304 of FIG. 3.

Alternatively, the hybrid 736 could feed both sets of matching circuits, i.e, set 804, 805 and set 808, 809, directly and switches 803, 807 could be placed between the outputs of the matching circuits and the antennas so that, when the switches 803, 807 are in a first switching state, the UFO outputs are directed to dipoles 302 and 304 and when the switches 803, 807 are in a second switching state, the MUOS outputs are directed to dipoles 302 and 304.

Physically, the placement of the switching circuit 800 can be located anywhere within, on, or otherwise electrically coupled to one of the antenna embodiments, e.g., 300, 600, or 700.

Since there will be a transition period prior to the full implementation of the MUOS, in accordance with an embodiment of the present invention, the coaxial switches 803, 807 could be set to a normally close position (shown in FIG. 8) so that communication is, by default, routed through the UFO matching network 804. When communication with the MUOS is desired, the user can utilize measures to cause the switches 8003, 807 to direct the signal through the MUOS matching network 805, 809. One measure for causing the switches 803, 807 to change states is to apply a voltage to the switches 803, 807. For example, the available 24 V power source 806 from the aircraft can be routed through the switches 803, 807.

In accordance with yet another embodiment of the present invention, the switches 803, 807 can be affected so that once the transition to the MUOS is complete, the normal state of the switches 803, 807 directs communication to and from the MUOS matching networks 805, 809 permanently, i.e., stays in that state until acted upon. For example, the exterior of the inventive antenna can be provided with a physical switch that can be activated, i.e., the state is selected, by a user to direct the normal path of the switches 803, 807. This can include an embodiment where an electrical pathway, accessible at an exterior of the antenna is removable or breakable or, alternatively, is connectable to direct a normal state of the switches 803, 807. For example, a signal path formed from a trace on an etched circuit board can be opened by simply scratching the path with a tool, thereby breaking the conductivity of the path.

Advantageously, because the switches 803, 807 are present within the inventive antenna and can be affected to selectively direct in electrical pathway through one of at least two high-efficiency matching circuits, the present invention can be immediately utilized in the present UFO system and work equally as well with the upcoming MUOS.

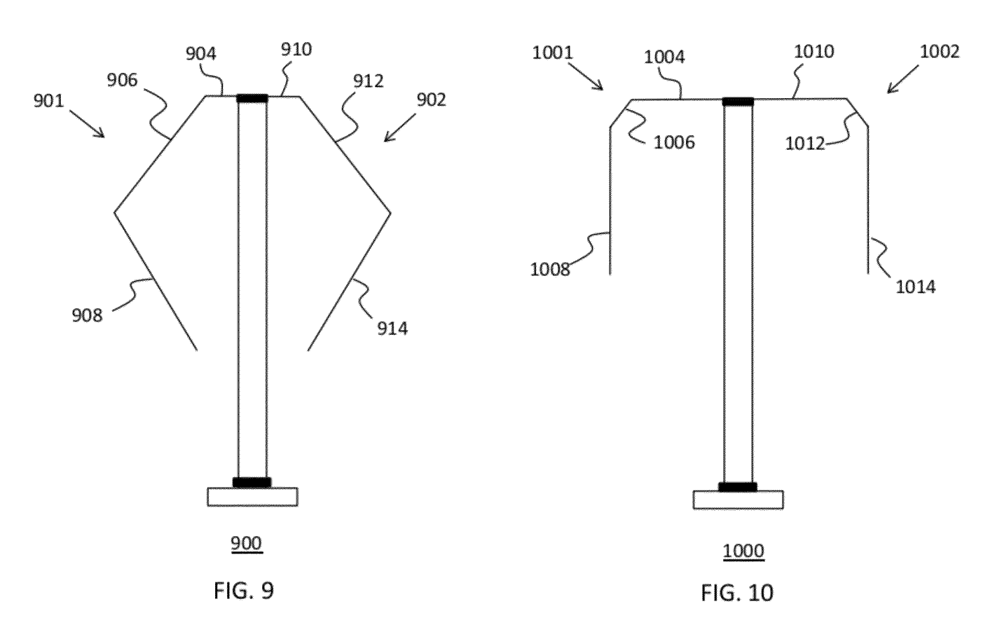

FIGS. 9 and 10 provide alternative exemplary embodiments of the present invention. Referring first to FIG. 9, an inventive antenna 900 is shown in an elevational side view where only two radiators are illustrated. The radiators include a first radiator 901 and an opposing second radiator 902. Other than the shape of the radiating elements 901, 902, the functionality and components of the antenna 900 are the same as the previous embodiments of the inventive antennas shown and described above. Therefore, unless specifically described as varying from the above description, the relevant details of the previously-described antennas are included herein by reference.

Unique to antenna 900 is the shape of the radiators 901, 902. In this embodiment, each radiator 901, 902 includes three portions. Specifically, radiator 901 includes a horizontal portion 904, a first angled portion 906, and a second angled portion 908. Radiator 902 is mirror symmetrical to the first radiator 901 and also includes a horizontal portion 910, a first angled portion 912, and a second angled portion 914. The horizontal and angled portions defining each radiating element can be utilized to advantageously affect the overall radiation pattern of the inventive antenna 900.

Similarly, the inventive antenna 1000 shown in FIG. 10 is illustrated in an elevational side view where only two radiators are illustrated. The radiators include a first radiator 1001 and an opposing second radiator 1002. Other than the shape of the radiating elements 1001, 1002, the functionality and components of the antenna 1000 are the same as the previous embodiments of the inventive antennas shown and described above. Therefore, unless specifically described as varying from the above description, the relevant details of the previously-described in antennas are included herein by reference.

Unique to antenna 1000 is the shape of the radiators 1001, 1002. In this embodiment, each radiator 1001, 1002 includes three portions. Specifically, radiator 1001 includes a horizontal portion 1004, a first angled portion 1006, and a second angled portion 1008. Radiator 1002 is mirror symmetrical to the first radiator 1001 and also includes a horizontal portion 1010, a first angled portion 1012, and a second angled portion 1014. The horizontal and angled portions defining each radiating element can be utilized to advantageously affect the overall radiation pattern of the inventive antenna 1000.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An antenna assembly comprising:
an antenna/radio interface;
a body section connected to the antenna/radio interface; and
a group of omnidirectional radiating elements, each radiating element:
having a first portion with a first end and a second end, the first end being coupled to the body section and the second end being opposite the first end;
having a second portion with a first end, a second end, and a linear section between the first end and the second end, the first end of the second portion being coupled to the second end of the first portion and the second end of the second portion being opposite the first end of the second linear portion; and
arranged so that:
the first portion of each element is substantially coaxially aligned with the first portion of at least one other element in the group of omnidirectional radiating elements and substantially orthogonal to the first portion of at least two other elements in the group of omnidirectional radiating elements; and
the linear section of each second portion is parallel with the linear section of each other element in the group of omnidirectional radiating elements,
wherein the first portion and the second portion meet at a non-zero angle to each other.

2. The antenna assembly according to claim 1, wherein:
the first portion defines a first plane; and
the second portion defines a second plane, wherein the first plane is non-parallel to the second plane.

3. The antenna assembly according to claim 1, wherein:
each first portion and the linear section of each second portion includes a substantially planar conductive surface.

4. The antenna assembly according to claim 1, wherein the body section comprises:
an elongated section having a first end a second end, the antenna/radio interface being coupled to the first end of the elongated section and the group of omnidirectional radiating elements being connected at the second end of the elongated section.

5. The antenna assembly according to claim 4, wherein the body section comprises:
a balun coupled to the elongated section.

6. The antenna assembly according to claim 1, further comprising:
an impedance-matching network electrically coupled between the antenna/radio interface and the group of omnidirectional radiating elements.

7. The antenna assembly according to claim 1, further comprising:
a 90° hybrid electrically coupled between the antenna/radio interface and the group of omnidirectional radiating elements.

8. The antenna assembly according to claim 1, wherein:
at least a portion of one of the first portion and the second portion of the group of omnidirectional radiating elements is formed on a printed circuit board.

9. The antenna assembly according to claim 1, wherein:
the second end of the second portion is spaced away from the body section by a distance.

10. The antenna assembly according to claim 1, further comprising:
a first impedance-matching network tuned to a first frequency band and electrically coupled between the antenna/radio interface and the group of omnidirectional radiating elements;
a second impedance-matching network tuned to a second frequency band, different from the first frequency band, and electrically coupled between the antenna/radio interface and the group of omnidirectional radiating elements; and
a switch selectable between the first impedance-matching network and the second impedance-matching network.

11. The switch according to claim 10, further comprising:
a normally-selected first switching state;
a selectable second switching state different from the first switching state; and
a switching element physically movable to permanently select the second switching state.

12. The switch according to claim 11, wherein:
the switching element is accessible from an exterior of the antenna assembly.

13. The antenna assembly according to claim 1, wherein each radiating element further comprises:
a third portion with a first end and a second end, the first end of the third portion being coupled to the second end of the second portion and the second end of the third portion being opposite the first end of the third portion,
wherein the third portion and the second portion meet at non-zero angle to each other.

14. The antenna assembly according to claim 13, wherein:
the first portion, the second portion, and the third portion each lie in a plane, wherein each plane is different from the other.

15. An antenna assembly comprising:
an elongated body having a first end and a second end opposite the first end;
an upper element-supporting portion physically coupled to the first end of the elongated body and supporting a first portion of each of four elements, the first portion of each element being aligned substantially coaxially with the first portion of at least one other of the four elements and substantially orthogonal to the first portion of at least two other of the four elements; and
a lower element-supporting portion coupled to the upper element-supporting portion and supporting a second portion of each of the four elements, the second portion of each of the four elements having a substantially linear portion and wherein the first portion and the second portion of each element are conductively coupled.

16. The antenna assembly according to claim 15, wherein the upper element-supporting portion is substantially planar.

17. The antenna assembly according to claim 15, wherein the lower element-supporting portion is a continuous piece of material.

18. The antenna assembly according to claim 15, wherein the lower element-supporting portion is between the first end and the second end of the elongated body.

19. The antenna assembly according to claim 15, wherein the first portion of each of the four elements is fed by an impedance matching circuit.

20. The antenna assembly according to claim 15, wherein the four elements are at least partially formed by conductive pathways etched on a printed circuit board.

21. The antenna assembly according to claim 15, further comprising:
an antenna/radio interface coupled to the elongated body;
a first impedance-matching network tuned to a first frequency band and electrically coupled between the antenna/radio interface and the four omnidirectional radiating elements;
a second impedance-matching network tuned to a second frequency band, different from the first frequency band, and electrically coupled between the antenna/radio interface and the four omnidirectional radiating elements; and
a switch selectable between the first impedance-matching network and the second impedance-matching network.
